(19) United States
(12) Patent Application Publication
(10) Pub. No.: US 2005/0036179 A1
(43) Pub. Date: Feb. 17, 2005

(54) Holographic storage medium comprising metal-containing high refractive index region, and storage article containing same

(75) Inventors: Bret Ja Chisholm, Clifton Park, NY (US); Anis Zribi, Schenectady, NY (US); Ivy Wai Man Chong, Scotia, NY (US); James Alan Resue, Scotia, NY (US)

Correspondence Address: General Electric Company;CRD Patent Docket Rm 4A59, Bldg. K-1, P.O. Box 8, Schenectady, NY, 12301, US

(73) Assignee: General Electric Company

(21) Appl. No.: 10/640,707

(22) Filed: Aug. 13, 2003

(51) Int. Cl. G03H 1/00

(52) U.S. Cl. 359/3; 359/1

(57) ABSTRACT

Holographic storage media comprise two substrates and a core between them, the core comprising thermoplastic photopolymer and a titanium or zirconium compound as a high refractive index material. During photopatterning of the storage medium precursor, the titanium or zirconium compound migrates toward the patterned region or the matrix region surrounding it, causing a refractive index difference which provides optimum holographic properties.

### BACKGROUND OF THE INVENTION

This invention relates to data storage devices, and more particularly to contrast-enhanced holographic storage media and devices incorporating them.

Digital storage media for data have improved significantly over the past several years. After the development initially of floppy disks and, later, high capacity disks of a similar design, the onset of compact disk technology was a major advancement and led in turn to DVD development. Further, both of these technologies have been improved in the form of write-once and repeatably writable disks, including CD write-once (CDR), DVD write-once (DVDR), CD rewrite (CDRW) and DVD rewrite (DVDRW). The storage capacity of these media has vastly increased with each of these developments. However, the requirements for data storage media continue to increase and media of still greater storage capacity are constantly being sought.

One relatively new form of storage is holographic storage, wherein data are typically stored pagewise in a three-dimensional array by laser writing. Typically, recording or “writing” light passes through a two-dimensional array of dark and transparent areas representing data. The holographic system stores the data in three dimensions where the holographic representations of the pages occur as patterns of varying refractive index imprinted into a storage medium. The holographic data storage typically consists of a distribution of gratings having varying tilt angles with separations proportional to periods caused by the angular bandwidth of the data pages that are recorded. Reconstructive or “reading” light is diffracted at a well defined angle of incidence (the Bragg angle) with respect to the gratings.

Photopolymeric materials are adaptable for use in producing such media, with patterning of a photopolymerizable being achieved by polymerization with a laser of one or more suitable monomers in a polymerizable matrix material, the laser beam being employed in combination with a reference beam. Following patterning, the matrix is uniformly polymerized to form a permanent medium, from which the data may be read by a reading laser beam, i.e., a reference beam similar to that employed in the writing step.

An essential feature of a holographic storage medium is a significant difference in index of refraction between the patterned and matrix areas. This is difficult to achieve using polymers of ethylenically unsaturated monomers, since the index of refraction difference between such polymers is generally quite small. The effective maximum in index of refraction for such polymer systems is on the order of 1.70 for polymers of pentabromobenzyl acrylate. Refractive index differences attributable to still higher index of refraction values could produce systems offering more promise. Such properties simply cannot be obtained in exclusively polymeric materials.

The technology of holographic data storage is more fully described in numerous publications. Illustrative are Psaltis et al. “Holographic Memories”, Scientific American, November 1995, 70-76; U.S. Pat. Nos. 5,759,721, 5,874,187, 6,103,454, 6,221,536, 6,322,932 and 6,348,983; and U.S. patent application publication 2001/0050786. These publications disclose, as storage media, lithium niobate and various polymeric compositions. Lithium niobate is very expensive and not available in amounts suitable for large-scale commercial use. The polymers described suffer, as noted hereinabove, from low refractive index contrast.

In Oliveira et al., Met. Res. Soc. Symp. Proc., 435, 553-558 (1998), holographic storage media are described as being prepared from colloidal zirconium-containing nanoparticles “based on 3-methacryloxypropyl trimethoxysilane (MPTS) and zirconium propylate (Zr), chelated by methacrylic acid (MA)”. There is no clear description of the actual composition of the polymerizable material converted to the storage medium, or of the method for its preparation and use.

U.S. Pat. No. 6,329,058 describes metal oxide nanoparticles that may be combined with transparent polymer compositions to form ceramers useful in various optical applications, but not in holographic data storage. The metal oxide nanoparticles may be produced by the hydrolysis of a metal alkoxide in the presence of a C₃₋₁₈ aliphatic carboxylic acid as dispersing agent.

It would be desirable, therefore, to develop polymeric holographic data storage media containing additive materials having the effect of increasing the difference in refractive index between the patterned and matrix regions.

### BRIEF DESCRIPTION OF THE INVENTION

The present invention includes holographic storage media and devices including them, said media comprising a core of polymeric material in combination with a metallic material that confers a significant difference in refractive index. The metal employed therein is at least one of titanium and zirconium. During patterning of the monomeric precursor of the polymeric material, entropy changes between the monomer and the polymer cause migration of the metal particles into either a patterned region or a matrix region of the core and produce a refractive index gradient between the two regions.

In one embodiment, the invention is a holographic storage medium comprising:
first and second substrates spaced apart from each other, at least one of said substrates comprising a thermoplastic resin; and
a core between said substrates, said core comprising at least one thermoplastic photopolymer and being adapted to store information and comprising at least one patterned region and at least one matrix region;
said patterned region being rich in a compound of at least one metal selected from the group consisting of titanium and zirconium and said patterned region comprising an addition polymer of at least one methacrylate-functionalized compound of said metal in the form of nanoparticles, and
said matrix region comprising an addition polymer of at least one C₄₋₇ t-alkyl acrylate and being depleted, relative to said patterned region, in said metal.

A further embodiment is a holographic storage medium comprising:
first and second substrates spaced apart from each other, at least one of said substrates comprising a thermoplastic resin; and
a core between said substrates, said core comprising at least one thermoplastic photopolymer and being adapted to store information and comprising at least one patterned region and at least one matrix region;
said matrix region being rich in at least one metal selected from the group consisting of titanium and zirconium in the form of nanoparticles, said metal existing in association with at least one non-addition polymerizable dispersing agent and comprising an addition polymer of at least one (meth)acrylate monomer which is compatible with said dispersing agent; and
said patterned region comprising an addition polymer of at least one (meth)acrylate monomer and being depleted, relative to said patterned region, in said metal.

A still further embodiment is a method for preparing a holographic storage medium comprising:
(A) constructing a storage medium precursor comprising:
first and second substrates spaced apart from each other, at least one of said substrates comprising a thermoplastic resin; and
first and second substrates spaced apart from each other, at least one of said substrates comprising a thermoplastic resin; and
a polymerizable core between said substrates, said core comprising at least one C₄₋₇ t-alkyl acrylate and at least one methacrylate-functionalized compound, in the form of nanoparticles, of a metal selected from the group consisting of titanium and zirconium;
(B) polymerizing a portion of said core by laser writing, thus producing a patterned region containing data, said patterned region being rich in said metal; and
(C) immobilizing said patterned region by blanket polymerization of the remainder of said core, thus producing a matrix region.

A yet further embodiment is a method for preparing a holographic storage medium comprising:
(A) constructing a storage medium precursor comprising:
first and second substrates spaced apart from each other, at least one of said substrates comprising a thermoplastic resin; and
a polymerizable core between said substrates, said core comprising at least one (meth)acrylate monomer and at least one non-polymerizable compound, in the form of nanoparticles, of a metal selected from the group consisting of titanium and zirconium;
(B) polymerizing a portion of said core by laser writing, thus producing a patterned region containing data, said patterned region being depleted in said metal; and
(C) immobilizing said patterned region by blanket polymerization of the remainder of said core, thus producing a matrix region.

Further embodiments are holographic storage devices comprising
a coherent light source;
a holographic multiplexing mechanism that causes an interaction between an object beam and a reference beam derived from said coherent light source; and
a holographic storage medium of one of the types described hereinabove.

### DETAILED DESCRIPTION; PREFERRED EMBODIMENTS

The holographic storage medium of the present invention comprises first and second spaced-apart substrates of which at least one comprises a thermoplastic resin; the other is also preferably a thermoplastic resin but may be of another material, typically glass. Most preferably, the two substrates are both of thermoplastic resin and of the same lateral dimension. Suitable thermoplastic resins will be apparent to those skilled in the art from the above-cited publications.

The storage medium also comprises a core comprising at least one thermoplastic photopolymer between said first and second substrates, said core comprising at least one patterned region and at least one matrix region. The patterned region is created by laser writing of at least one monomer which is a precursor of the photopolymer. Following laser writing, the remaining monomer in the matrix region is polymerized in bulk, producing the core in its final form.

Another constituent of the core precursor is a compound of at least one metal selected from the group consisting of titanium and zirconium, preferably titanium, these metals being chosen by reason of their availability, their relatively low cost and the high index of refraction of compounds thereof that exist in the form of nanoparticles. By “nanoparticles” is meant particles having a mean diameter up to 200 nm. Preferably, the particle diameter is up to 100 nm, more preferably up to about 70 nm and most preferably in the range of about 4-10 nm, as determined by light scattering or electron microscopy.

According to a first embodiment of the holographic storage media of the invention, the monomeric photopolymer precursors include at least one C₄₋₇ t-alkyl acrylate which is polymerized to form the matrix region. Suitable acrylates include the t-butyl, 2-methyl-2-butyl, 2-methyl-2-pentyl and 3-ethyl-3-pentyl acrylates; t-butyl acrylate is generally preferred by reason of its relatively low cost and particular suitability. In particular, it has a relatively low refractive index combined with a glass transition temperature above room temperature (i.e., above about 25° C.), which properties are of significant interest in the production of holographic storage media.

This embodiment also includes the use of at least one methacrylate-functionalized compound of said metal as a precursor of the patterned region. Preparation of such compounds in nanoparticle sol form may be achieved by contacting an acidic solution in an alkanol of an alkoxide of the desired metal with at least one methacryloxyalkyltrialkoxysilane, preferably 3-methacryloxypropyltrimethoxysilane.

The core may be prepared by blending the precursors therefor, i.e., the t-alkyl acrylate and the methacrylate-functionalized metal compound in sol form, usually in solution in a solvent such as the previously mentioned alkanol and concentrating the solution, most of ten under reduced pressure as in a rotary evaporator. The resulting concentrated solution is combined with a photoinitiator and the combination is positioned between the two substrate layers, forming a holograph intermediate. Suitable materials for use as photoinitiators are identified in U.S. Pat. Nos. 4,576,850 and 6,103,454 and in such reference works as Encyclopedia of Polymer Technology. Examples are benzoin ethers, hydroxy- and alkoxyalkyl phenyl ketones, thioalkylphenyl morpholinoalkyl ketones and acylphosphine oxides. Particularly useful in many instances is 2-benzyl-2-(dimethylamino)-4′-morpholinobutyrophenone.

It is also within the scope of the invention to incorporate a sensitizer in the core. Sensitizers have the effect of rendering the photoinitiator active upon exposure to radiation of wavelengths other than those normally employed in an operation such as laser writing. Thus, for example, certain photoinitiators are normally effective only upon exposure to far-ultraviolet radiation, but in the presence of sensitizers they become effective when exposed to radiation in the visible region. Sensitizers and their proportions of use are described, for example in the aforementioned U.S. Pat. Nos. 5,759,721 and 6,221,536.

Relative proportions of the constituents of the core precursor may vary widely depending on such factors as the print density of the pages to be written thereto. Most often, either monomeric constituent comprises about 20-80% and preferably about 40-60% by weight of the total of such constituents, with metal percentages generally being up to about 25%. The photoinitiator and, optionally, sensitizer are present in minor amounts effective to promote polymerization upon exposure to the radiation employed; for the photoinitiator, this is generally in the range of about 0.005-3.0% and preferably about 0.005-1.0% based on total polymerizable components.

In one embodiment of the method of this invention, laser writing on the core is performed by art-recognized methods, typically as described in the aforementioned patents and other publications relating to holographic data storage. During said laser writing, diffusion of the metal-containing monomer into the patterned (i.e., polymerized) region has been found to occur preferentially. It is believed that this is the result of preferential conversion of the methacrylate moieties of the metal oxide particles due to hyperconjugative stabilization of the methacrylate free radical by the electron-rich methyl group, creating an entropy reduction causing a thermodynamic driving force for diffusion of the metal oxide-containing monomer into the area being illuminated by the laser beam. However, the invention is not dependent on this or any other theory of operation. In any event, it has been found that said diffusion results in the patterned region being rich in metal.

Following laser writing, the patterned region is immobilized by polymerization of the matrix region. This can be easily achieved by blanket illumination of the entire core, whereupon photoinitiated bulk polymerization occurs. Since the refractive index of the metal compound is significantly higher than that of the t-alkyl acrylate polymer, there is a contrast in refractive index that enhances the effectiveness of the resulting storage medium as a readable holographic unit.

In other embodiments of the holographic storage media and method of the invention, this phenomenon is reversed. That is, the thermodynamic driving force caused by the polymerization process produces diffusion of the metal compound into the matrix (i.e., non-polymerized by laser action) region of the core. This may be achieved by providing the metal in the form of a non-polymerizable compound, complex or other combination with the use of a non-addition polymerizable dispersing agent.

The matrix region in this embodiment comprises a monomeric precursor which, in this instance, may be any (meth)acrylate (i.e., acrylate or methacrylate) monomer which is compatible with the metal compound; e.g., methyl acrylate, ethyl acrylate, methyl methacrylate or ethyl methacrylate. Suitable dispersing agents for the metal compound include C₃₋₁₈ aliphatic carboxylic acids as disclosed in the aforementioned U.S. Pat. No. 6,329,058, and organosilanes such as hexyltrimethoxysilane, octyltriethoxysilane, dodecyltriethoxysilane, phenyltrimethoxysilane and phenethyltrimethoxysilane. The proportions of constituents employed are generally about the same as in the first embodiment.

Upon laser writing of such a system, the thermodynamic driving force created by the polymerization reaction promotes diffusion of the metal particles out of the region being polymerized, creating a refractive index difference with the opposite mode of that created in the first embodiment. However, the result, from the standpoint of effectiveness as a holographic storage medium, is the same.

In the holographic storage devices of the invention, the coherent light source is generally a laser, which may be tunable in wavelength. The holographic multiplexing mechanism changes the angle of incidence of the light beam on the holographic storage medium. Each hologram that is multiplexed at the same location in the holographic storage medium is stored at a different angle. The holographic storage medium receives and stores interference patterns resulting from the interaction between the object beam and a reference beam from the multiplexing mechanism. The details of construction and operation of such holographic storage devices is known to those skilled in the art and is described in many of the patents and publications mentioned hereinabove, all of which are incorporated herein by reference.

The invention is illustrated by the following examples. All percentages are by weight.

### EXAMPLE 1

Titanium tetraisopropoxide, 105 g, was slowly added to a rapidly stirred mixture of 1,000 g of isopropanol, 49.05 g of concentrated (37%) hydrochloric acid and 5.25 g of deionized water. The solution was allowed to stir at room temperature for 48 hours. Then 13.75 g of 3-methacryloxypropyltrimethoxysilane was quickly added to the rapidly stirred solution. The solution was heated at 50° C. for 5 hours. t-Butyl acrylate, 200 g, was slowly added to 200 g of the resulting sol with rapid stirring. The solution was vacuum stripped until 81 g remained, of which 12.7 g was removed as product; the product was the desired sol of the titanium compound in the form of nanoparticles dispersed in t-butyl acrylate.

### EXAMPLE 2

The remaining 68.9 g of the product of Example 1 was further vacuum stripped to a weight of 32 g.

### EXAMPLES 3-4

The products of Examples 1-2 were used for recording a diffraction grating, an experiment often used as a proof of concept of holographic data storage capability. Various concentrations of photoinitiator, 0.2˜0.5%, and proportions of nanoparticles (typically less than 25%) were employed. Droplets of the composition were spread between two sapphire plates, and the thickness of the film was controlled by a titanium shim sandwiched between the sapphires. A quartz plate was used as a platform to support the recording medium.

Polymerization was effected with a 200 mW argon laser at a wavelength of 333 nm. The optical setup included a shutter, an expander, an aperture and a set of two mirrors. The recording medium was positioned at the intersection of the beams reflected by the two mirrors where an interference fringe pattern was created. The pattern characteristics were controlled by manipulating the angle between the two mirrors and thus between the interfering beams. This grazing angle was varied in the range of 2-7°.

The writing process began when the direct beam sent from the first mirror and the reflected beam generated from the second mirror interacted to produce an interference wavefront that exposed the sample to a system of bright and dark fringes. This spatially modulated irradiation initialized the diffusion of the high refractive index titanium-containing nanoparticles from low intensity areas towards high intensity areas where polymerization occurred. The driving force for diffusion was the chemical potential created upon conversion of monomer and methacrylate-functional metal compound to polymer. The laser writing operations were carried out for 10-20 sec, after which the written patterns were immobilized via a full irradiation with uniform ultraviolet light for 20 min to polymerize the matrix. Diffraction gratings were thus obtained.

### EXAMPLE 5

Titanium tetraisopropoxide, 105 g, is slowly added to a rapidly stirred mixture of 1,000 g of isopropanol, 49.05 g of concentrated (37%) hydrochloric acid and 5.25 g of deionized water. The solution is allowed to stir at room temperature for 48 hours. Then 10.87 g of hexyltrimethoxysilane is quickly added to the rapidly stirred solution. The solution is heated at 50° C. for 5 hours. Methyl methacrylate, 200 g, is slowly added to 200 g of the resulting titanium-containing sol with rapid stirring. The solution is vacuum stripped until 81 g remained; the product is the desired titanium-containing sol in the form of nanoparticles dispersed in methyl methacrylate.

### EXAMPLE 6

The product of Example 5 is converted to a diffraction grating by the procedure of Examples 3-4. In this example, diffusion of the high refractive index nanoparticles is from high intensity areas where polymerization occurs towards low intensity areas.

While typical embodiments have been set forth for the purpose of illustration, the foregoing descriptions and examples should not be deemed to be a limitation on the scope of the invention. Accordingly, various modifications, adaptations, and alternatives may occur to one skilled in the art without departing from the spirit and scope of the present invention.

1. A holographic storage medium comprising:
first and second substrates spaced apart from each other, at least one of said substrates comprising a thermoplastic resin; and
a core between said substrates, said core comprising at least one thermoplastic photopolymer and being adapted to store information and comprising at least one patterned region and at least one matrix region;
said patterned region being rich in a compound of at least one metal selected from the group consisting of titanium and zirconium and said patterned region comprising an addition polymer of at least one methacrylate-functionalized compound of said metal in the form of nanoparticles, and
said matrix region comprising an addition polymer of at least one C₄₋₇ t-alkyl acrylate and being depleted, relative to said patterned region, in said metal.

2. A storage medium according to claim 1 wherein the metal is titanium.

3. A storage medium according to claim 2 wherein both of said substrates comprise a thermoplastic resin.

4. A storage medium according to claim 2 wherein the titanium is functionalized with 3-methacryloxypropyltrimethoxysilane.

5. A storage medium according to claim 2 wherein the t-alkyl acrylate is t-butyl acrylate.

6. A holographic storage device comprising
a coherent light source;
a holographic multiplexing mechanism that causes an interaction between an object beam and a reference beam derived from said coherent light source; and
a holographic storage medium according to claim 1.

7. A storage device according to claim 6 wherein the metal is titanium.

8. A storage device according to claim 6 wherein both of said substrates comprise a thermoplastic resin.

9. A storage device according to claim 6 wherein the titanium is functionalized with 3-methacryloxypropyltrimethoxysilane.

10. A method for preparing a holographic storage medium comprising:
(A) constructing a storage medium precursor comprising:
first and second substrates spaced apart from each other, at least one of said substrates comprising a thermoplastic resin; and
first and second substrates spaced apart from each other, at least one of said substrates comprising a thermoplastic resin; and
a polymerizable core between said substrates, said core comprising at least one C₄₋₇ t-alkyl acrylate and at least one methacrylate-functionalized compound, in the form of nanoparticles, of a metal selected from the group consisting of titanium and zirconium;
(B) polymerizing a portion of said core by laser writing, thus producing a patterned region containing data, said patterned region being rich in said metal; and
(C) immobilizing said patterned region by blanket polymerization of the remainder of said core, thus producing a matrix region.

11. A method according to claim 10 wherein the metal is titanium.

12. A method according to claim 11 wherein both of said substrates comprise a thermoplastic resin.

13. A method according to claim 11 wherein the titanium is functionalized with 3-methacryloxypropyltrimethoxysilane.

14. A method according to claim 11 wherein the t-alkyl acrylate is t-butyl acrylate.

15. A holographic storage medium comprising:
first and second substrates spaced apart from each other, at least one of said substrates comprising a thermoplastic resin; and
a core between said substrates, said core comprising at least one thermoplastic photopolymer and being adapted to store information and comprising at least one patterned region and at least one matrix region;
said matrix region being rich in a compound of at least one metal selected from the group consisting of titanium and zirconium in the form of nanoparticles, said metal existing in association with at least one non-addition polymerizable dispersing agent and comprising an addition polymer of at least one (meth)acrylate monomer which is compatible with said dispersing agent; and
said patterned region comprising an addition polymer of at least one (meth)acrylate monomer and being depleted, relative to said patterned region, in said metal.

16. A storage medium according to claim 15 wherein the metal is titanium.

17. A storage medium according to claim 16 wherein both of said substrates comprise a thermoplastic resin.

18. A storage medium according to claim 16 wherein the titanium is functionalized with an organosilane.

19. A storage medium according to claim 16 wherein the titanium is functionalized with a C₃₋₁₈ aliphatic carboxylic acid.

20. A holographic storage device comprising
a coherent light source;
a holographic multiplexing mechanism that causes changes in interaction between an object beam and a reference beam derived from said coherent light source; and
a holographic storage medium according to claim 15.

21. A storage device according to claim 20 wherein the metal is titanium.

22. A storage device according to claim 21 wherein both of said substrates comprise a thermoplastic resin.

23. A storage device according to claim 21 wherein the titanium is functionalized with a tetraorganosilane.

24. A storage device according to claim 21 wherein the titanium is functionalized with a C₃₋₁₈ aliphatic carboxylic acid.

25. A method for preparing a holographic storage medium comprising:
(A) constructing a storage medium precursor comprising:
first and second substrates spaced apart from each other, at least one of said substrates comprising a thermoplastic resin; and
a polymerizable core between said substrates, said core comprising at least one (meth)acrylate monomer and at least one non-polymerizable compound, in the form of nanoparticles, of a metal selected from the group consisting of titanium and zirconium;
(B) polymerizing a portion of said core by laser writing, thus producing a patterned region containing data, said patterned region being depleted in said metal; and
(C) immobilizing said patterned region by blanket polymerization of the remainder of said core, thus producing a matrix region.

26. A method according to claim 25 wherein the metal is titanium.

27. A method according to claim 26 wherein both of said substrates comprise a thermoplastic resin.

28. A method according to claim 26 wherein the titanium is functionalized with an organosilane.

29. A method according to claim 26 wherein the titanium is functionalized with a C₃₋₁₈ aliphatic carboxylic acid.

30. A holographic storage medium comprising:
first and second substrates spaced apart from each other, each of said substrates comprising a thermoplastic resin; and
a core between said substrates, said core comprising at least one thermoplastic photopolymer and being adapted to store information and comprising at least one patterned region and at least one matrix region;
said patterned region being rich in a titanium compound and said patterned region comprising an addition polymer of 3-methacryloxypropyltrimethoxysilane-functionalized titanium in the form of nanoparticles, and
said matrix region comprising an addition polymer of t-butyl acrylate and being depleted, relative to said patterned region, in said metal.

31. A holographic storage device comprising
a coherent light source;
a holographic multiplexing mechanism that causes an interaction between an object beam and a reference beam derived from said coherent light source; and
a holographic storage medium according to claim 30.
